(19) United States
(12) Patent Application Publication
(10) Pub. No.: US 2021/0103879 A1
(43) Pub. Date: Apr. 8, 2021

(54) SYSTEM AND METHOD FOR LABOR SCHEDULING AND JOBSITE MANAGEMENT

(71) Applicant: Viceroy, Inc., Pasadena, TX (US)

(72) Inventors: Timothy Michael Hoch, Pasadena, TX (US); Julie Doyle, Pasadena, TX (US); Bruce Bever, Pasadena, TX (US); Richard Jake Locklear, Pasadena, TX (US); Dawn Lynn Manning, Pasadena, TX (US); Cindy Lee Staton, Pasadena, TX (US)

(21) Appl. No.: 16/592,114

(22) Filed: Oct. 3, 2019

(51) Int. Cl. G06Q 10/06

(52) U.S. Cl. CPC G06Q 10/063118; G06Q 10/06316; G06Q 10/0637; G06Q 10/06313

(57) ABSTRACT

A system for labor scheduling and jobsite management is disclosed that manages a dynamically changing workforce. The system includes a graphical user interface (GUI) and a processor circuit that controls the GUI. The system provides a plurality of user-selectable input screens that allow input of information regarding employee onboarding, flexible staffing and workflow management, time entry/payroll support, significant event reporting, and medical protocol management. The system receives user input from one or more of the user-selectable input screens and generates, and dynamically updates, a plurality of work schedules for a respective plurality of workers having different skills working on different aspects of a job at different times as the job progresses. The system further manages time keeping, payroll, benefits, and medical protocols for workers beginning and ending work at different times as the job progresses to thereby pay each worker at the completion of their assignment irrespective of other workers.

### BRIEF DESCRIPTION OF THE DRAWINGS

The accompanying drawings are part of this disclosure and are incorporated into the specification. The drawings illustrate example embodiments of the disclosure and, in conjunction with the description and claims, serve to explain various principles, features, or aspects of the disclosure. Certain embodiments of the disclosure are described more fully below with reference to the accompanying drawings. However, various aspects of the disclosure may be implemented in many different forms and should not be construed as being limited to the implementations set forth herein. Like numbers refer to like, but not necessarily the same or identical, elements throughout.

FIG. 1 illustrates a first view of a software interface provided on a graphical user interface (GUI), in accordance with one or more embodiments of the disclosure.

FIG. 2 illustrates a second view of a software interface provided on a GUI, in accordance with one or more embodiments of the disclosure.

FIG. 3 illustrates a further view of a software interface provided on a GUI showing information related to operations management, in accordance with one or more embodiments of the disclosure.

FIG. 4 illustrates a view of a software interface provided on a GUI showing information related to management of job shifts, in accordance with one or more embodiments of the disclosure.

FIG. 5 illustrates a view of a software interface provided on a GUI showing information related to management of employees, in accordance with one or more embodiments of the disclosure.

FIG. 6 illustrates a view of a software interface provided on a GUI showing functionality to record a daily log, in accordance with one or more embodiments of the disclosure.

FIG. 7 illustrates a view of a software interface provided on a GUI showing functionality to specify various job hazards, in accordance with one or more embodiments of the disclosure.

FIG. 8 illustrates a view of a software interface provided on a GUI showing functionality to specify and manage medical protocols, in accordance with one or more embodiments of the disclosure.

FIG. 9 illustrates a view of a software interface provided on a GUI showing functionality to specify and modify safety alerts, in accordance with one or more embodiments of the disclosure.

FIG. 10 illustrates a view of a software interface provided on a GUI showing functionality to schedule drug testing procedures, in accordance with one or more embodiments of the disclosure.

FIG. 11 illustrates a view of a software interface provided on a GUI showing functionality to specify and manage weld reviews, in accordance with one or more embodiments of the disclosure.

FIG. 12 illustrates a view of a software interface provided on a GUI showing functionality to manage audits, in accordance with one or more embodiments of the disclosure.

FIG. 13 illustrates a view of a software interface provided on a GUI showing functionality to specify and manage customer experience surveys, in accordance with one or more embodiments of the disclosure.

FIG. 14 illustrates a view of a software interface provided on a GUI showing functionality to manage time tracking, in accordance with one or more embodiments of the disclosure.

FIG. 15 illustrates a view of a software interface provided on a GUI showing functionality to initiate and manage reports and notifications, in accordance with one or more embodiments of the disclosure.

FIG. 16 is a flow chart illustrating a processor-implemented method of labor scheduling and jobsite management for a dynamically changing workforce, in accordance with one or more embodiments of the disclosure.

FIG. 17 is a block diagram of an example computer system, in which disclosed embodiments may be implemented, according to an embodiment of the present disclosure.

### DETAILED DESCRIPTION

Disclosed embodiments provide systems and methods of labor scheduling and jobsite management. These embodiments provide functionality to organize and efficiently manage all aspects of a job, including employee onboarding, flexible staffing and workflow management, time entry/payroll support, significant event reporting, medical protocol management, and related capabilities. The disclosed systems and methods may be used to manage the unique challenges posed by jobs requiring teams of craft labor workers. For example, a craft labor job may be a construction site that requires various different teams of workers having different skills working on different aspects of a construction job at different times. Workers needed in the beginning phases of a job may not be needed in middle and end phases of a job. As such, many craft labor jobs have unique scheduling challenges associated with a work force that is dynamically changing as the job progresses.

Disclosed embodiments provide a flexible mechanism to process individual workers through a payroll system to quickly remove and pay one or more workers as needed. In this regard, the system provides a mechanism to quickly “layoff/payoff” temporary workers who have completed their assignments. In contrast, conventional systems only process workers as a batch process and it may be difficult to add and remove workers using such systems. The disclosed systems are flexible in that they are customizable to account for special circumstances (e.g., union rules applying to union workers assigned to craft labor teams). A disclosed software system includes five major components: (1) an operations management platform, (2) a time tracking platform, (3) a self-service portal, (4) an integrated learning management system, and (5) a third-party billing platform. All of these components can feed and/or pull data from a single Enterprise Resource Planning (ERP) system or multiple ERPs or other data sources. This unique combination of system components provide a functionality that is not found in conventional systems.

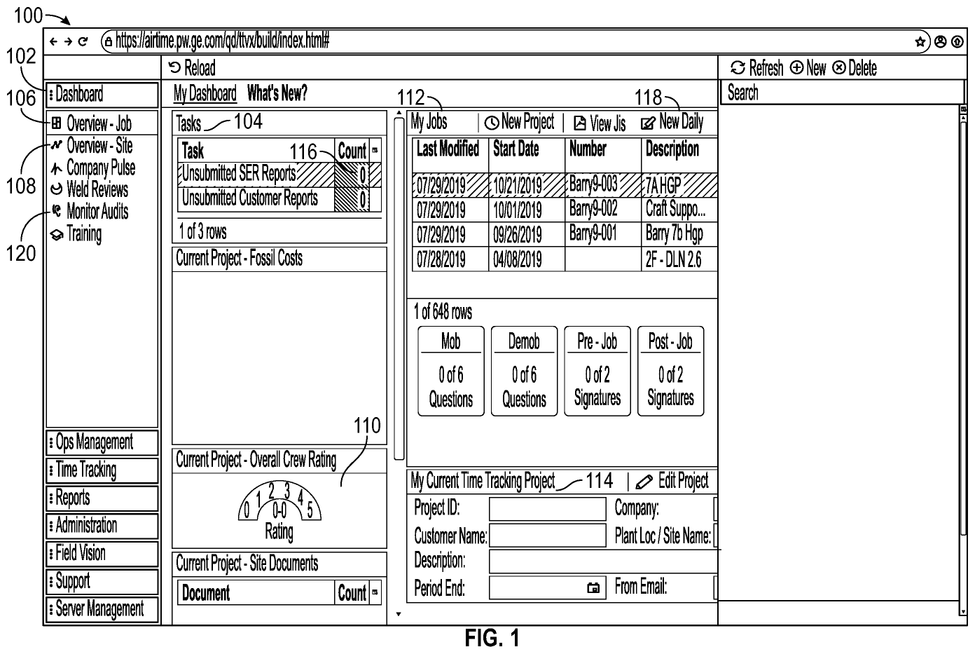

FIG. 1 illustrates a first view 100 of a software interface provided on a graphical user interface (GUI), in accordance with one or more embodiments of the disclosure. A software interface such as shown in FIG. 1 may provide access to all of the system's components and functionality. For example, disclosed systems may include a dashboard 102 that is displayed on the GUI. The dashboard may provide specific job information, including a targeted task list 104 customized for each supervisor or superintendent. The dashboard may provide an at-a-glance snapshot of the job 106, the jobsite 108, work performance 110 (current project costs, crew rating, etc.), due and overdue tasks, significant event reports, etc. The dashboard may further include a job queue 112 that provides functionality that allows superintendents to manage a current job and to begin forecasting upcoming jobs. In this regard, the job queue 112 enhances pre-planning and completion of pre-job tasks. The dashboard may further include a time tracking utility 114.

A dashboard screen, such as shown in FIG. 1, provides functionality to help a user see a big picture view of all the information provided by the software interface. Some of the dashboard screens show information specific to the role of the current user, and some display the same information to everyone. According to an embodiment, each user may see similar types of information but some of the information is tailored specifically to the user that is logged in. The list of jobs provided in the job queue 112 may be sorted by last modified job so the most recently touched jobs will sort to the top. These are typically the jobs that are going to be of most interest to the user logged in. From the jobs queue 112 it is possible to select an individual job and then use the buttons at the top of the software interface to perform various operations with the selected job as the context.

Targeted task list 104 is a list of items that may be relevant to the current user. Items not requiring attention may be displayed with green color indicator 116. Items displayed with a red color indicator (not shown in this example) may require the user's attention. A user may then focus on an item indicated in red by selecting the item. For example, an item may be selected using a input received by the GUI through user interaction. A user may use an input device, such as a mouse, to select an item by clicking or double clicking the item using the input device. Selecting an item in this way may cause the GUI to change the appearance of information associated with the selected item. For example, the GUI may present a new screen or new window in the GUI (not shown in this example) that may present more detailed information regarding the selected item.

Time tracking utility 114 may allow a user to keep track of time associated with a given project. Some users won't have a current project and so an area associated with time tracking utility 114 may be blank (as shown in view 100 of FIG. 1). For other users with a current project, an area associated with time tracking utility 114 will display a summary (not shown in this example) for that current project. In such a situation, time tracking utility 114 may provide user-selectable buttons to allow the user to access various additional pieces of information regarding time tracking of the current project.

Work performance 110 may be indicated by an overall crew rating. Such a rating gives a quick visual indication of an overall rating for a crew for a current time tracking project. This is a rating that is averaged over all evaluations that have been submitted for the members of the crew over their entire work history. When a project is initiated, the rating may have an initial value of 0.0, as shown. As the project progresses and evaluations for various phases of the project are submitted, the rating may increase to indicate an overall performance of the crew.

Information regarding a current work site may be obtained by selecting a user-selectable option regarding the jobsite 108. Selection of the jobsite 108 option may cause the GUI to modify the content of displayed information. For example, selecting the jobsite 108 item may cause the GUI to display a new screen or window (not shown) that provides a history of the jobsite that is tied to the current time tracking project. This allows a superintendent to understand what has happened previously at the site where work is currently being performed. A daily logs utility 118 provides a list of system-supplied messages and may contain information about new updates or new releases of the system software.

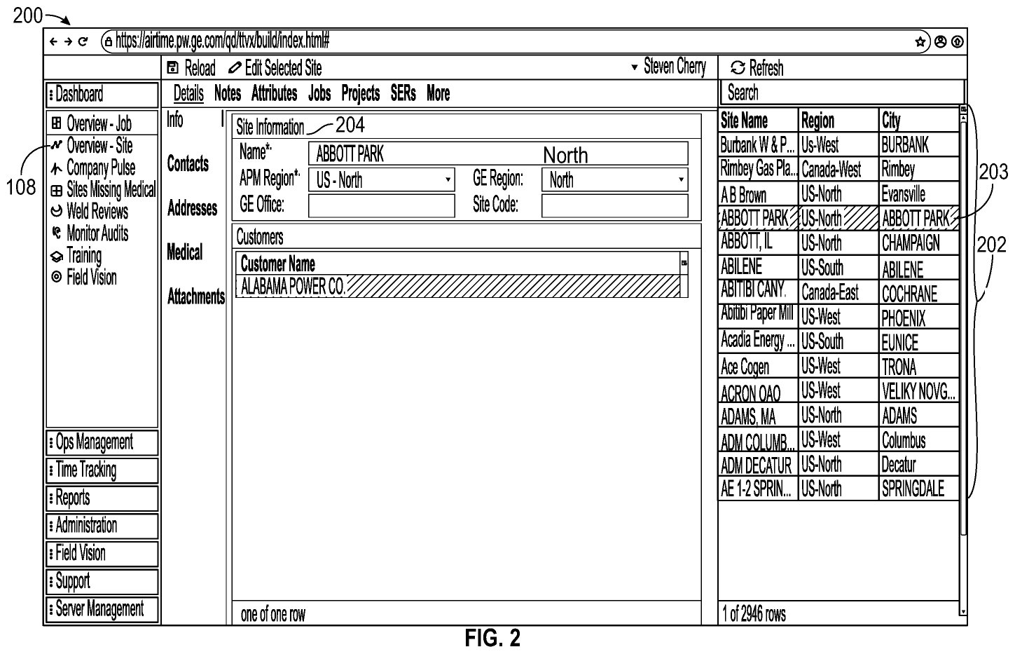

FIG. 2 illustrates a second view 200 of a software interface provided on a GUI, in accordance with one or more embodiments of the disclosure. View 200 is generated by the GUI in response to a user selecting jobsite 108 that was shown in FIG. 1. View 200 provides detailed information regarding one or more job sites. View 200 shows information about the various sites that are defined in the system. A list 202 of sites is displayed on the right in a searchable list and details for the currently selected site 203 are shown in the editor 204 area in the middle of view 200. In this example, the editor is configured to only allow read access. As such, there is no way to save any changes that are made in this editor. Editor 204 may provide search features. When searching the list 202 of sites, editor 204 may match a search entry against various search fields including: site name, site code, region name, site main address (e.g., state, zip or postal code, city), etc. In this read-only editor 204, the information displayed may be chosen to be the most useful for superintendents and others trying to get a feel for a site before they make a trip out to a job site for a first visit.

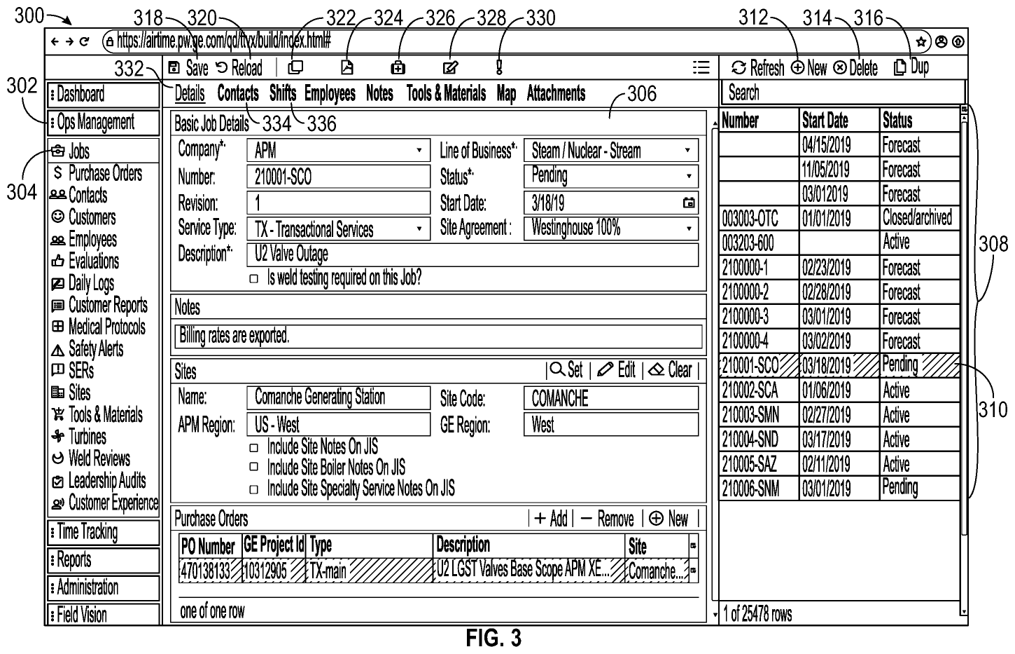

FIG. 3 illustrates a further view 300 of a software interface provided on a GUI showing information related to operations management, in accordance with one or more embodiments of the disclosure. View 300 is generated by the GUI when a user selects the “ops management” tab 302 and the “jobs” tab 304. When a user selects tab 302, the GUI closes the listing of dashboard entries shown in FIG. 2 and opens the listing of entries pertaining to operations management. Tab 302 provides a collection of screens and user-selectable options that allow a user to plan, provision, and to track job performance metrics. Tab 302 provides a single-entry point for the creation of job crew rosters. Once entered, a job roster is available to all other components of the software system. As such, problems that may otherwise arise due to duplicate entries may be avoided.

Selection of tab 304, under tab 302, invokes a job editor 306 as shown. Editor 306 handles maintenance of job records using a standard layout to present a list 308 of records already in the system. Selection of single record 310 from list 308 causes editor 308 to display information about the single record. List 308 may be configured as a searchable list. A search may be performed by entering a search field in a search box. List 308 may be automatically filtered based on a user-specified search criterion.

List 308 may be edited to add new records and to delete existing records. For example, a user may add a new record by selecting the “new” icon 312. Upon selection of icon 302, editor 306 may present a blank form that may be filled with information regarding the new record. An existing record may be deleted when a user selects the “delete” icon 314. For some situations, it may be advantageous to create a duplicate record. In this regard, a duplicate record may be created when a user selects the “dup” icon 316. For example, a duplicate record may be created having a job name and job number that are the same as an existing job. Such a record may be distinguished from an existing record by the presence of a revision counter (e.g., revision-1, revision-2, etc.). List 308 may further be searched according to search fields including: job number, job status, line of business, company name, site name, etc.

Job records may be edited using various user-selectable items. A save button 318, for example, allows any unsaved changes to be saved. In an embodiment, save button 318 may be displayed with a color status indicator. For example, “save” button 318 may be displayed having a red color (not shown) to indicate a presence of un-saved changes. Upon selecting save button 318, changes may be saved and a color indicator change (e.g., from red to green) may provide a visual indication (not shown) that the changes have been saved. Selection of a “reload” button 320 may cause the GUI to pull a most recent record from the system and load it into editor 306. A “copy job” button or icon 322 allows a user to make a copy of the job with a new job number. A “view pdf” button or icon 324 allows a user to view a summary of job details in standard PDF format. A “view MTP” button or icon 326 allows a user to view a medical treatment protocol that is associated with a job. A “create job log” button or icon 328 allows a user to create a daily log for a job. A “SER” button or icon 330 allows a user to create a Significant Event Report (“SER”) for the job.

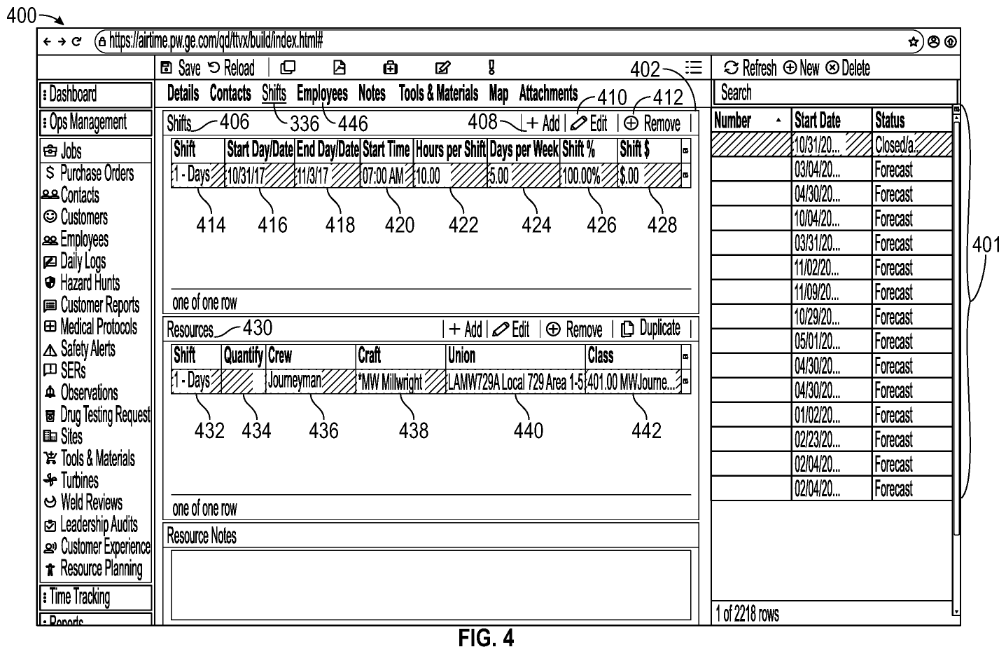

Various aspects of job creation and management are provided by the various screens that may be invoked in response to selection of various user-selectable menu items. For example, the above-described features of FIG. 3 are provided through selection of the “details” menu item 332. A further screen providing contact information may be obtained by selecting the “contacts” 334 menu item. As described in greater detail below with reference to FIG. 4, details of the various job shifts may be managed by invoking a job shifts screen by selecting a “shifts” button 336.

FIG. 4 illustrates a view 400 of a software interface provided on a GUI showing information related to management of job shifts, in accordance with one or more embodiments of the disclosure. As described above, view 400 may be generated by the GUI when a user selects “shifts” button 336. The shifts view 400 allows superintendents to identify jobsite resource needs (e.g., craft labor type, quantity, etc.), even without assigning individual craftsmen to positions. A list 401 of job shifts may be edited by an editor 402, which may provide similar functionality to that provided by job editor 306, described above with reference to FIG. 3. In this regard, a shifts 406 portion of editor 402 may allow creation of job shift records. For example, “add” button 408 allows creation of a new shift record, while “edit” button 410 allows modification of an existing job shift record. A “remove” button 412 allows a selected record to be deleted. As shown, a record may be created that specifies a number of required days 414, start day/date 416, end day/date 418, start time 420, hours per shift 422, days per week 424, a shift percentage 426, a shift pay rate 428, etc. In other embodiments, additional fields may be defined by a user.

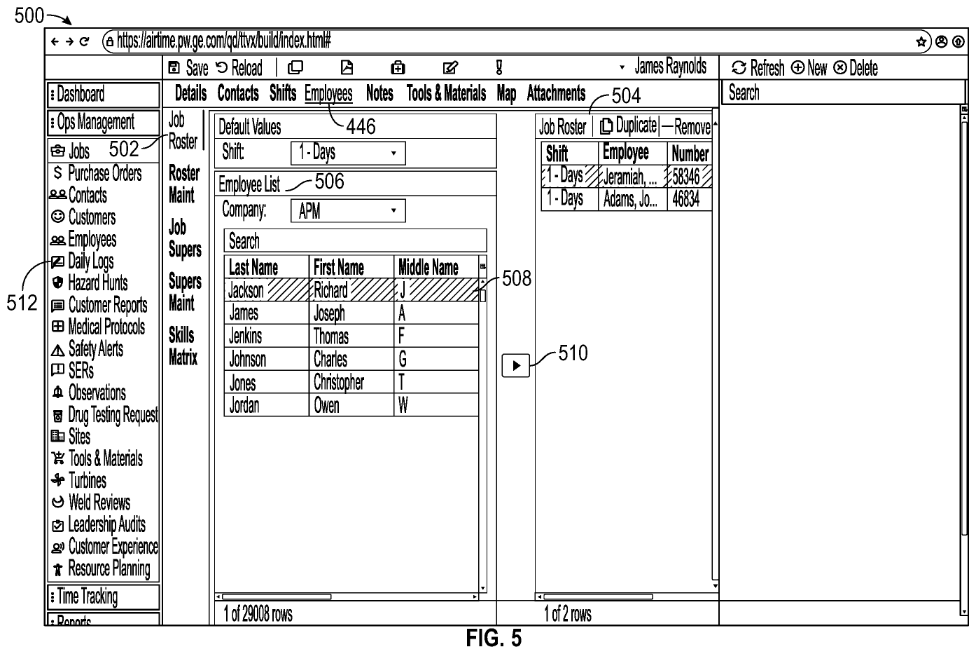

Editor 402 may further include a resource portion 430 of editor 402 that may allow available manpower resources to be searched and to be assigned. Resource attributes may include specification of a number of required days 432, a quantity 434 of a specific type of worker, a skill set 436 or type of craft worker 438, a union designation 440, a class designation 442, etc. As with shift portion 406, resource portion 430 of editor 402 may further allow a user to define additional fields to designate needed resources. As described in greater detail below with reference to FIG. 5, details of the various employees that may be assigned to job shifts may be managed by invoking an employee's screen by selecting an “employees” button 446.

FIG. 5 illustrates a view 500 of a software interface provided on a GUI showing information related to management of employees, in accordance with one or more embodiments of the disclosure. As described above, view 500 may be generated by the GUI when a user selects “employees” button 446. Functionality provided by view 500 may be used by a superintendent in identifying correct resources for a specific job. According to an embodiment, the system may be configured to cross reference site requirements, training requirements, employee requirements, and other pertinent information to create an ideal team for a job. Such cross-referenced information may be provided from various other screens that may be displayed by the GUI in response to various user-selections. The resource planning capability of the system also provides overall visibility of craft availability and scheduling to all levels of the business, including resource managers, general managers, and corporate personnel. One major benefit is a systematic overview of all assigned and available craftsmen for a given time period, simplifying management of the entire pool of craftsmen.

Each employee may be categorized according to their individual skills and training. In some embodiments, the GUI may be configured to provide visual indicators that provide information regarding an employee's skills/training. For example, the system may provide a red/green visual indicator (not shown) indicating a breakdown of an employee's qualifications. For example, desirable skills for a particular job may be highlighted in green (not shown) while deficits may be highlighted in red (not shown). Such visual indicators may give a superintendent a graphical overview of how well a selected crew meets jobsite requirements. Any shortfalls that need to be addressed before the job starts may be highlighted using a visual indicator (e.g., a text box highlighted in red), as described above. Granular control of this functionality allows a superintendent to tailor the overview of job qualifications to the needs of a particular job.

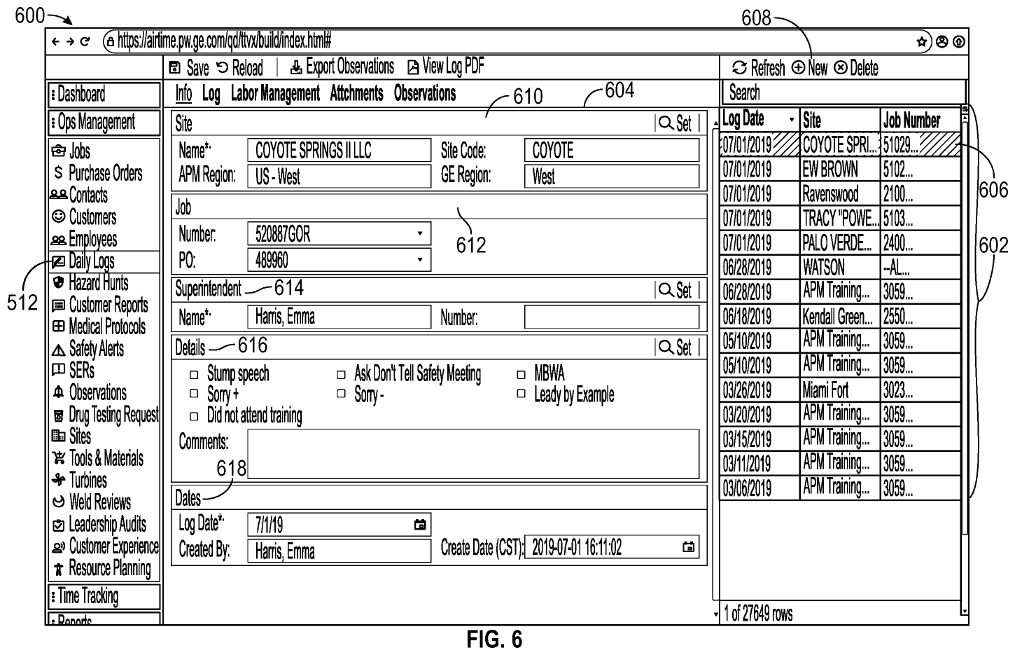

View 500 shows a job roster page that may be displayed by the GUI in response to a user selection of the “job roster” button 502. A roster 504 for a given job may be created by selecting employees from a list 506 of employee candidates. In this example, an employee 508 has been selected from list 506. The selected employee 508 may be added to roster 540 when a user selects a transfer button 510 that transfers the selected employee 508 from the list 506 of potential employees to roster 504. As described in greater detail below with reference to FIG. 6, a daily log screen may be invoked when a user selects a “daily logs” button 512.

FIG. 6 illustrates a view 600 of a software interface provided on a GUI showing functionality to record a daily log that is invoked when a user selects a “daily logs” button 512, in accordance with one or more embodiments of the disclosure. In this regard, the system incorporates user-defined selection capabilities for sharing daily logs. Superintendents can select which portions of logs are shared with specific groups such as third-party contractors, customers, field engineers, or corporate leadership. View 600 includes a list 602 of daily logs and a daily log editor 604. Selection of a specific log 606 by a user causes the GUI to load information about log 606 into editor 604. Editor 604 may then be used to update or correct information associated with log 606. A “new” button 608 may be selected to create a new log. As shown, editor 604 includes forms that allow information to be recorded regarding a job site 610, a specific job 612, a superintendent 614, details 616 of the log, dates 618, etc. Some embodiments allow creation of user-defined categories of information to be included in daily logs.

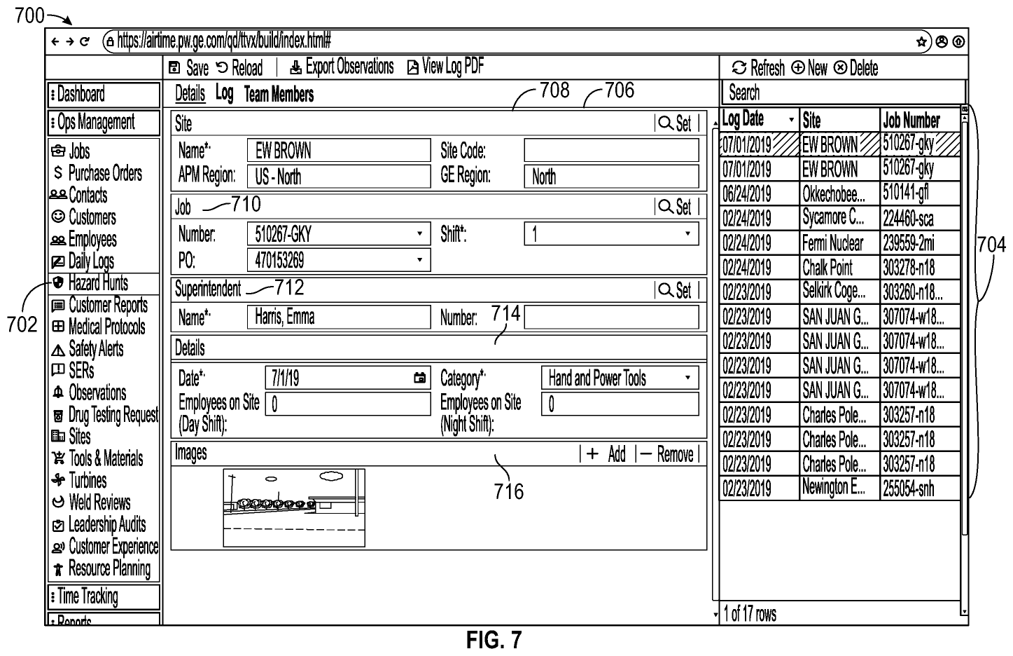

FIG. 7 illustrates a view 700 of a software interface provided on a GUI showing functionality to specify various job hazards, in accordance with one or more embodiments of the disclosure. The system may be configured so that the GUI presents view 700 in response to a user selecting the “hazard hunts” button 702. The functionality provided by view 700 is similar to that presented in other examples above. In this regard, view 700 includes a list 704 of selectable records and an editor 706. Records may be created, edited, and deleted as described in previous examples. In this example, editor 706 provides forms allowing entry of information regarding a particular site 708, a particular job 710, a superintendent 712 for the job 710, and various details 714 regarding potential hazards that may be encountered with job site 708 that is associated with job 710. Editor 706 further provides functionality to include one or more images 716. The functionality provided by view 700 allows “hazard hunt” guidelines to be defined and requirements to be pushed to superintendents in the field. Further, the “hazard hunt” page (i.e., view 700) provides management oversight of the program and ensures safety is always the top priority.

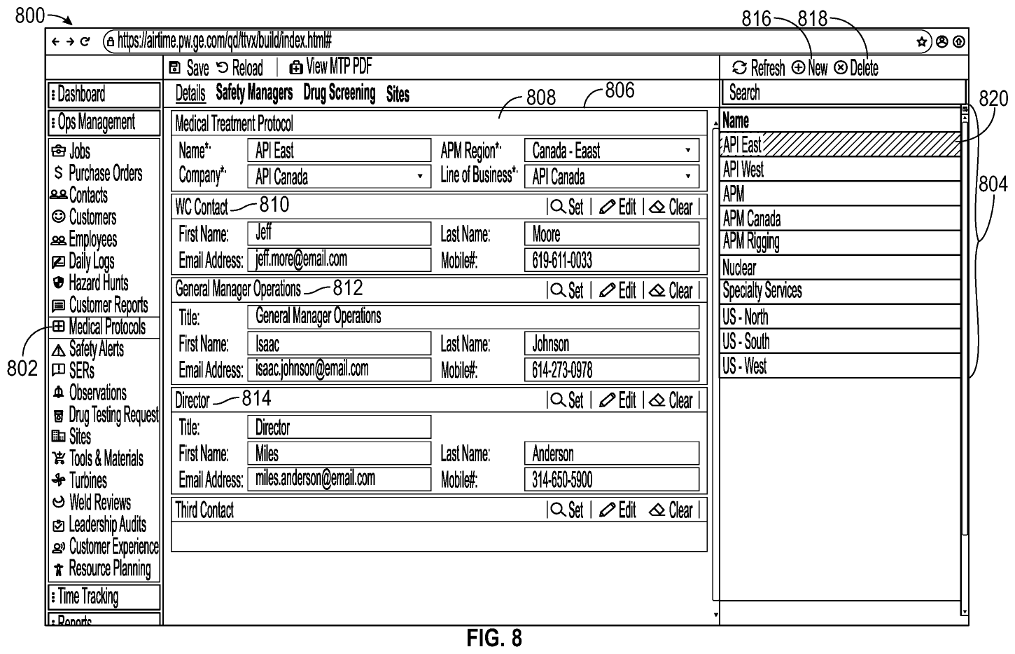

FIG. 8 illustrates a view 800 of a software interface provided on a GUI showing functionality to specify and manage medical protocols, in accordance with one or more embodiments of the disclosure. The system may be configured so that the GUI presents view 800 in response to a user selecting the “medical protocols” button 802. View 800 provides a comprehensive, step-by-step guide to company medical protocols and procedures including information regarding hospitals and clinics associated with each job site (e.g., closest facilities, maps, contact information, emergency services, etc.). View 800 includes a records list 804 and an editor 806. Editor 806 includes various forms that allow creation and management of information for medical treatment protocols 808, contact information 810, information regarding a general manager 812, a director 814, etc. Records list 804 allows records to be searched, new records to be created using the “new” button 816, and records to be deleted using the delete button 818. Selecting a particular record 820 causes the various forms 808, 810, 812, and 814 of editor 806 to be populated with information regarding record 820. Editor 806 may then be used to edit the information associated with record 820. Similarly, when a new record is created using “new” button 816, blank forms 808, 810, 812, and 814 may be presented that allow new information to be entered into the newly created record.

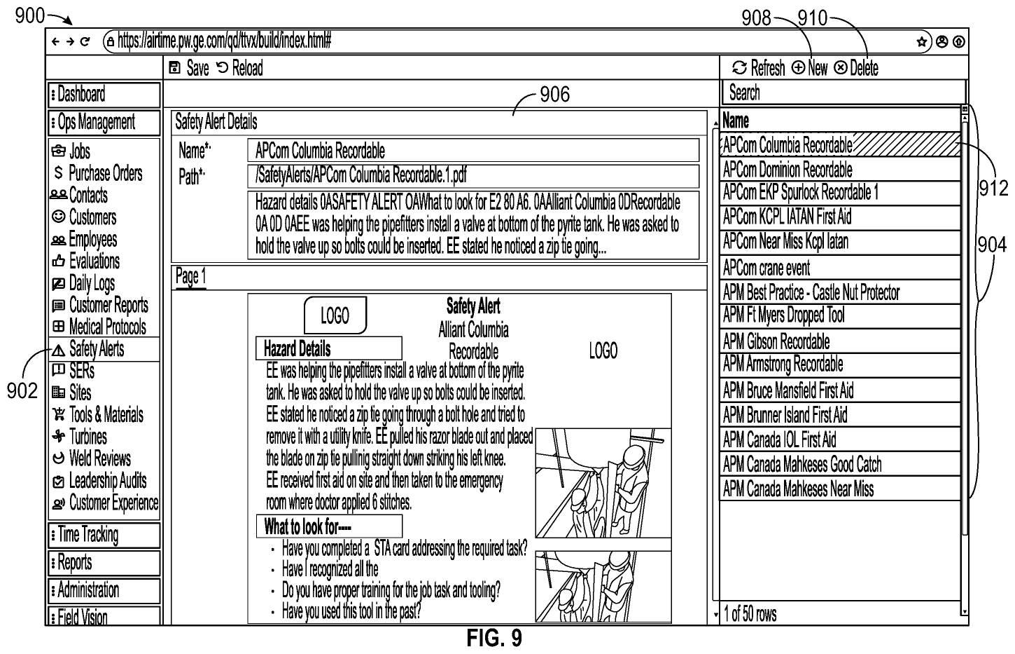

FIG. 9 illustrates a view 900 of a software interface provided on a GUI showing functionality to specify and modify safety alerts, in accordance with one or more embodiments of the disclosure. The system may be configured so that the GUI presents view 900 in response to a user selecting the “safety alerts” button 902. Disclosed embodiments may be configured so that safety alerts are mapped to applicable technologies and work scopes. Such a mapping ensures that safety alerts for a specific system or line of business are targeted to job sites and work scopes that employ those systems. View 900 allows management and safety professionals to push critical alerts using granular selection criteria (e.g., push to all superintendents, push specific job types, push based on specific work scopes, push to specific superintendents, etc.). View 900 includes a list 904 of safety alerts and an editor 906. New alerts may be created using the “new” button 908 and existing records may be deleted using the “delete” button 910. Existing records in list 904 may be searched using various search fields relating to the safety alert name and safety alert summary. Other embodiments may include other search criteria. Selecting a specific record 912 populates editor 906 with information regarding selected record 912. Editor 906 also allows information regarding the selected record 912 to be edited. Editor 906 may allow information for a newly created record to be entered.

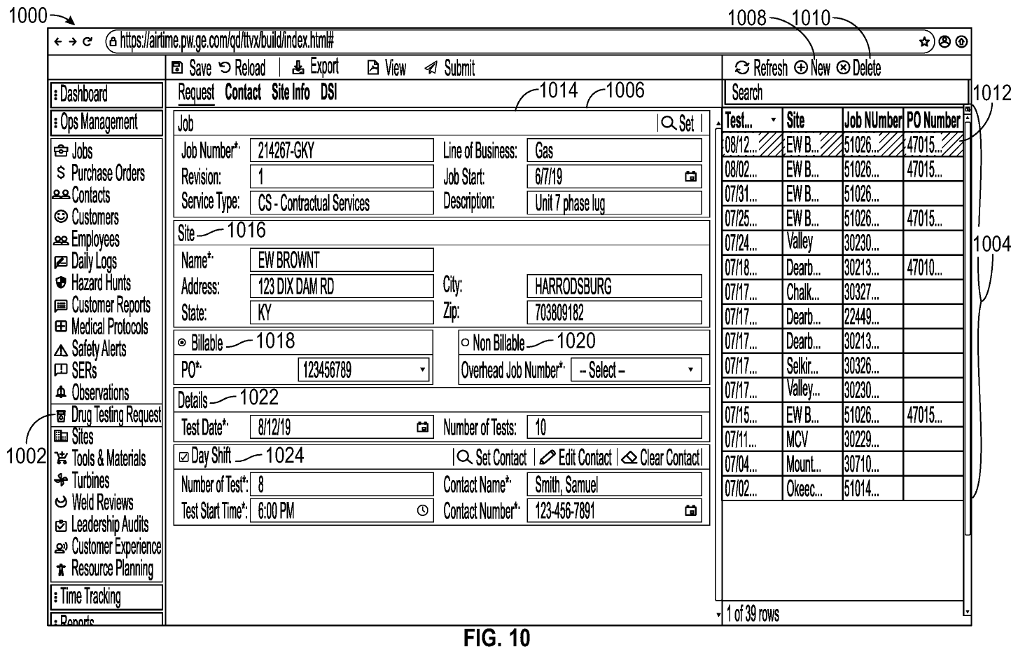

FIG. 10 illustrates a view 1000 of a software interface provided on a GUI showing functionality to schedule drug testing procedures, in accordance with one or more embodiments of the disclosure. The system may be configured so that the GUI presents view 1000 in response to a user selecting the “drug testing request” button 1002. Many jobs require workers to submit to a drug test in order to be qualified for the job. View 1000 leverages the job roster (described above) and billing capabilities to simplify and expedite drug tests for craftsmen on-site or during pre-job planning. View 1000 includes a list 1004 of scheduled tests and an editor 1006. New requests may be initiated when a user selects the “new” button 1008, and existing requests may be deleted using the “delete” button 1010. Editor 1006 allows information to be entered for a new requested test and allows information for a selected existing test 1012 to be edited. Editor 1006 includes forms that allow specification of details regarding the job 1014, the job site 1016, and whether the test is billable 1018 or non-billable 1020. Editor 1006 further allows test details 1022 and details regarding the work shift 1024 to be entered. Further embodiments may allow further information to be specified.

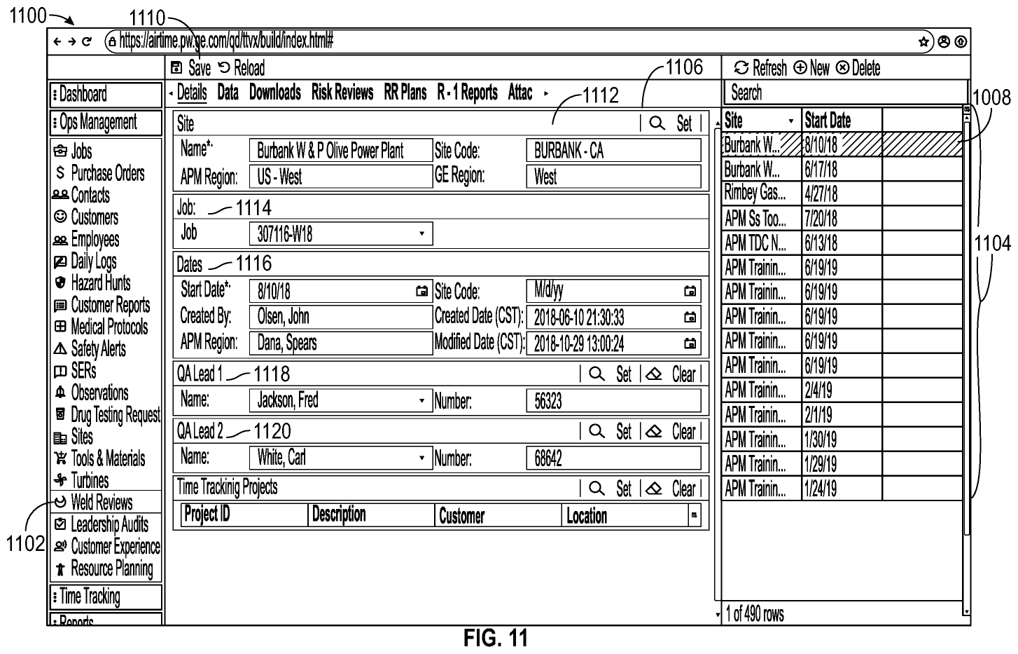

FIG. 11 illustrates a view 1100 of a software interface provided on a GUI showing functionality to specify and manage weld reviews, in accordance with one or more embodiments of the disclosure. The system may be configured so that the GUI presents view 1100 in response to a user selecting the “weld reviews” button 1102. View 1100 centralizes and digitizes a process that was previously a tedious paper process. The functionality provided by view 1100 further generates State documents and reports required for weld certification. View 1100 includes a list 1104 of weld reviews and a weld review editor 1106. Editor 1106 handles the maintenance of a portion of the current time tracking project that deals with weld review records. Various time tracking editors (described in greater detail below) work on a specific portion of the current time tracking project and work in conjunction with each other to track everything that goes on during execution of the project. When working with a weld review record 1108, required fields may be marked with a visual indicator (e.g., a red asterisk; not shown), and field validation may be applied prior to saving the record. According to this example, invalid data may be entered into editor 1106, but the data will be checked when the “save” button 1110 is invoked. As such, the system may be configured to prompt a user to fix invalid data prior to the data being saved to the system. Editor 1106 may include forms that allow specification of information regarding job site 1112, job 1114, and information regarding QA leads 1118 and 1120.

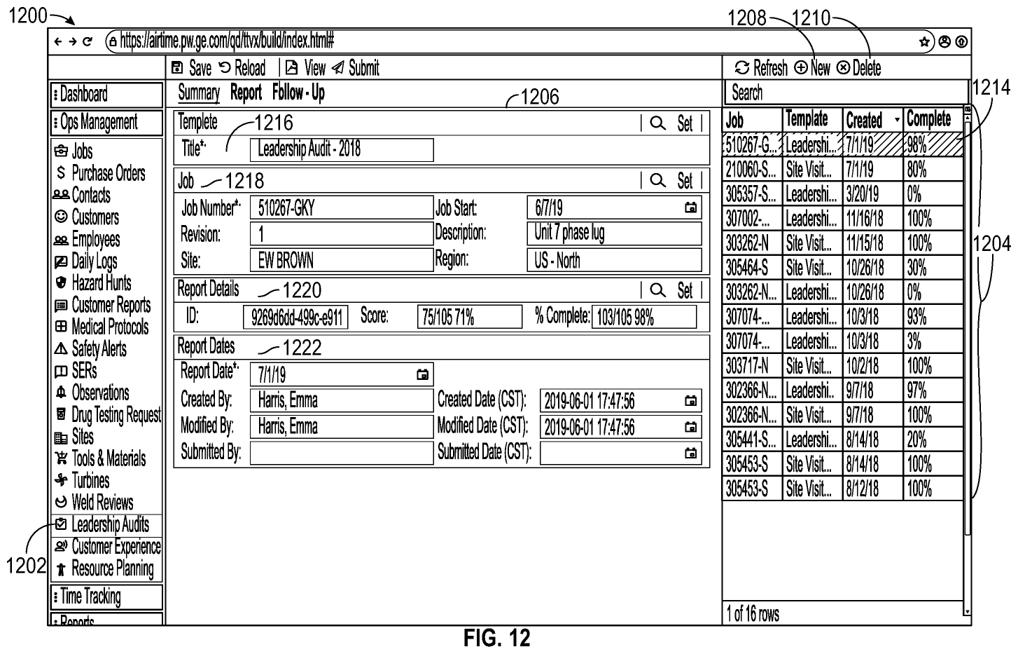

FIG. 12 illustrates a view 1200 of a software interface provided on a GUI showing functionality to manage audits, in accordance with one or more embodiments of the disclosure. The system may be configured so that the GUI presents view 1200 in response to a user selecting the “leadership audits” button 1202. View 1200 is part of a centralized, standardized audit system. Other examples of audits provided by the system include “monitor audits” 120 (e.g., see FIG. 1). The system further provides functionality to generate and share user-defined custom audits. View 1200 includes a list 1204 and an editor 1206.

A new audit may be generated when a user selects the “new” button 1208 and existing audits may be deleted using the “delete” button 1210. Existing audits may be searched using various criteria such as job number, template title, site name, superintendent name (e.g., first name . . . starts with, last name . . . starts with, etc.). Selecting a specific existing audit 1214 populates editor 1206 with information regarding the selected record 1214. Editor 1206 also allows information regarding the selected record 1214 to be edited. Editor 1206 may allow information for a newly created record to be entered. For example, editor 1206 provides forms for entry of a title 1216, information regarding a specific job 1218, report details 1220, report dates 1222, etc.

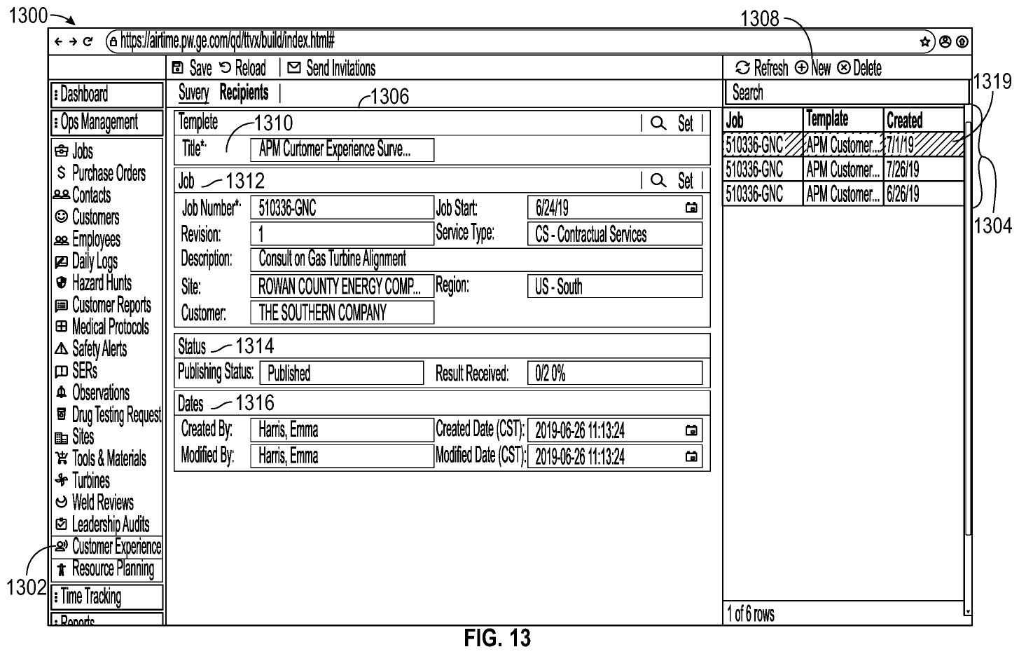

FIG. 13 illustrates a view 1300 of a software interface provided on a GUI showing functionality to specify and manage customer experience surveys, in accordance with one or more embodiments of the disclosure. The system may be configured so that the GUI presents view 1300 in response to a user selecting the “customer experience” button 1302. View 1300 provides functionality for a user to collect system performance data via customer experience surveys. In this regard, based on user input, the system may generate and send invitations to targeted individuals (e.g., customer representatives, plant owners, field engineers, etc.). The invitations may provide a request to the recipient to share feedback regarding their experience in using the system. Surveys also request recipients to share feedback on craft labor performance on the jobsite. These customer surveys may help to ensure company performance of assigned jobs/tasks exceed standards. Targeted surveys may ensure that performance feedback is provided by appropriate entities. View 1300 includes a list 1304 of surveys and an editor 1306. Selecting a specific existing survey 1318 populates editor 1306 with information regarding the selected survey 1318, and editor 1306 allows information regarding the selected survey 1318 to be edited. A new survey request may be generated when a user selects the “new” button 1308 and enters information regarding the new survey using editor 1306. Editor 1306 allows information to be entered including a survey title 1310, a job 1312 to which the survey refers, a status 1314 of the survey, and dates 1316 associated with collection of survey data.

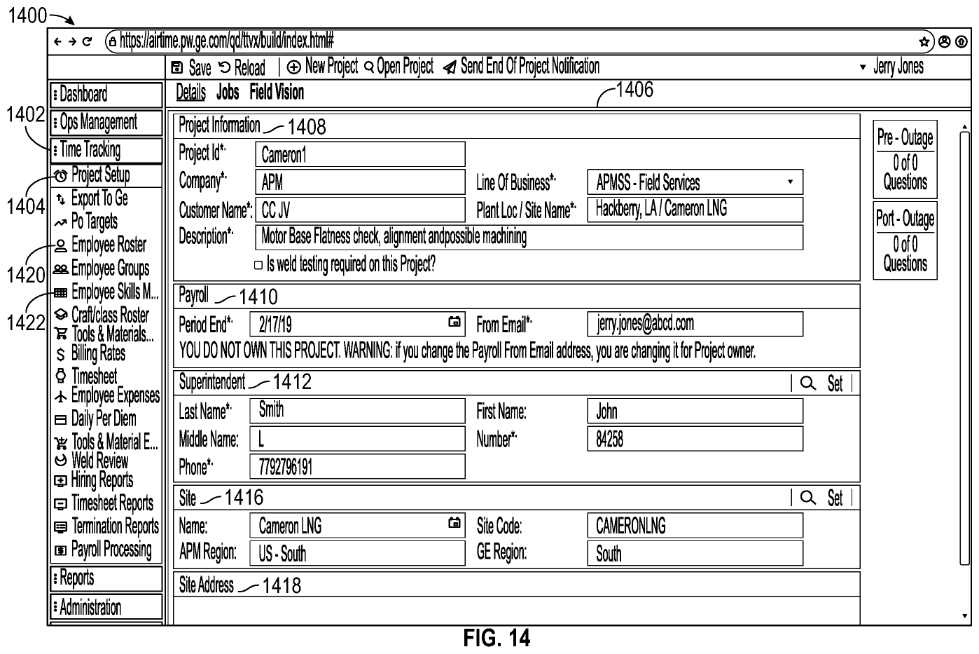

FIG. 14 illustrates a view 1400 of a software interface provided on a GUI showing functionality to manage time tracking, in accordance with one or more embodiments of the disclosure. The system may be configured so that the GUI presents view 1400 in response to a user selecting the “time tracking” tab 1402 and the “project setup” button 1404. The system provides a collection of screens that are designed to allow a job superintendent or job site clerk to track activities of all of the manpower involved in a specific job or job shift. This includes functionality to define crews, to track hiring and layoff paperwork, to enter and track expenses, to enter and track hours, and to prepare reports that may be submitted to a payroll department to drive paycheck creation.

View 1400 includes an editor 1406 that allows specification of project information 1408, payroll information 1410, superintendent information 1412, as well as information regarding the job site 1416, the site address 1418, etc. Various other screens may be accessed to allow additional time tracking functionality. For example, an employee roster page, an employee skills matrix page, etc., may be accessed by selecting respective buttons 1420, 1422, etc.

The system may further provide a “layoff is payoff” functionality. In this regard, union agreements require craft employees to be paid a final paycheck before they can be laid-off from a jobsite and returned to the union hall for re-assignment. Disclosed embodiments allow individual employees to be selectively pulled from the jobsite payroll batch and have their pay and union benefits dispersed immediately. No other time tracking system is known to have this capability. Disclosed embodiments further provide functionality to make payroll corrections, even to previously executed payroll actions. According to this functionality, a superintendent may simply correct the error to “what it should have been” and the backend system is configured to take care of correcting pay and benefits.

Additional embodiments provide functionality for third-party time tracking. This functionality provides significant flexibility that is not found in conventional time tracking systems. In this regard, the system may be configured to allow third-party contractors to enter time for the purpose of cost tracking and, as such, the entered third-party time is not processed as a payroll action. This unique feature creates a single repository of information regarding all jobsite costs. The ability to track and manage all costs for a given jobsite permits actual cost reporting and forecasting via a percent-complete value by activity. This functionality also permits tracking of sub-contracted personnel, third-party equipment, site material costs, etc. The system may further be configured to keep track of separate costs incurred by the primary user vs. those incurred by third-party contractors.

Additional functionality may allow reporting third-party timecards back to a third-party contractor for payroll processing. In this way, the system may be configured to natively track and to supply all aspects of customer financial reporting, including a pass-through capability to track third-party work hours and to either allow internal payroll processing, or to directly submit third-party work hours to a third-party payroll system. Further, the primary user may generate and submit bills to the end customer on behalf of the third-party contractor. As such, the system may provide a full centralized billing functionality for an entire job and may provide output that includes activity and progress reporting, as well as direct invoicing for end customers.

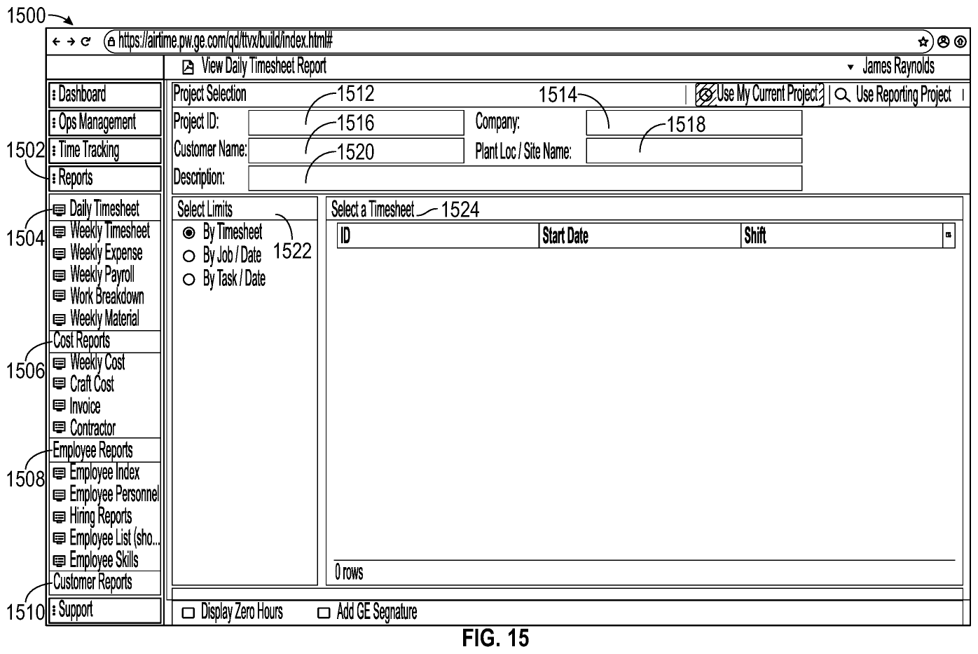

FIG. 15 illustrates a view 1500 of a software interface provided on a GUI showing functionality to initiate and manage reports and notifications, in accordance with one or more embodiments of the disclosure. The system may be configured so that the GUI presents view 1500 in response to a user selecting the “reports” tab 1502 and the “daily timesheet” button 1504. The system may be configured to allow customizable reporting and notification, including the ability to set groups for specific types of notifications. For example, a user may specify “significant event reports” (SER) to go to all senior leaders, termination notifications to go to payroll and operations leaders, etc.

Selection of various icons allows a user to generate various types of reports. For example, a user may select cost reports 1506, employee reports 1508, customer reports 1510, etc. View 1500 shows a screen associated with a “daily timesheet” 1504 report. As shown, the “daily timesheet” 1504 report includes an editor that allows entry of various pieces of information including a project ID 1512, a company name 1514, a customer name 1516, a plant location/site name 1518, and a description 1520. In this example, limits 1522 may be set by timesheet, by job/date, by task/date, etc., and various timesheets may be selected 1524 using a timesheet selection form. Various other reports may be generated using editors that provide similar functionality.

According to an embodiment, the system may provide a “self-service portal” to allow contractors and other third-parties to access the system. The self-service portal may be configured as an external system that allows workers to update personal information managed by the system. For example, a worker may use the self-service portal to provide information including name, address, basic contact information, I-9 and W-4 forms, and other information needed prior to the start of a job. The system may further allow workers to identify upcoming work opportunities and manage their job schedule. The self-service portal may further be configured to allow third-party contractors to push data such as hazard hunt results (e.g., see FIG. 7) to the system. This functionality may also allow the system to share appropriate information with third-party contractors.

The self-service portal may further include user-selectable pages that provide an “open calls” utility, an “onboarding” utility, a “pay and benefits” utility, and a “reporting” utility. The open calls utility is a labor forecasting tool for individual craftsmen. This tool may be configured to allow craftsmen from union halls across North America to view and volunteer for upcoming job opportunities, coordinate with site superintendents, and to plan/forecast follow-on work opportunities. The onboarding utility may be configured to be a web-based portal that permits craftsmen to complete pre-job tasks, including general and site-specific safety training, to update personal information (contact info, tax withholding, etc.), and to review company policies. The pay and benefits utility may be configured as an employee portal that allows craftsmen to view/download pay statements and other personal documents. The reporting utility may be configured to enable superintendents to proactively manage pre-job requirements by submitting crew preparation data to the system for completion and compliance reporting.

Further embodiments may include an integrated learning management system which is a comprehensive system that incorporates training courses for all required jobsite, safety, and annual training requirements. Functionality of this system allows integration of training requirements with pre job planning operations. This integration allows a superintendent to view status of crew training on a single, integrated dashboard which greatly improves informed decision-making.

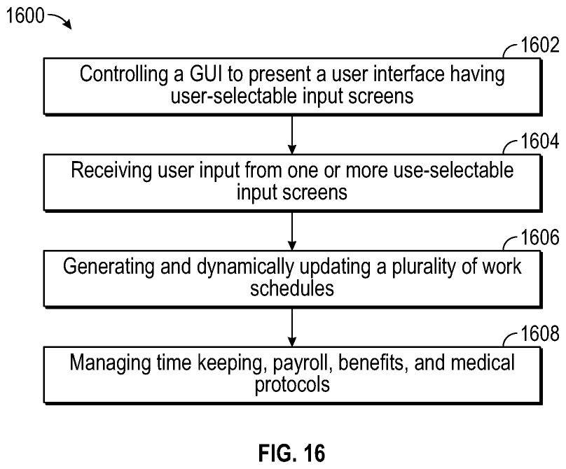

FIG. 16 is a flow chart illustrating a processor-implemented method 1600 of labor scheduling and jobsite management for a dynamically changing workforce, in accordance with one or more embodiments of the disclosure. In a first stage 1602, the method includes controlling, by a processor-circuit, a GUI to present a user interface that includes a plurality of user-selectable input screens that are configured to receive user input regarding employee onboarding, flexible staffing and workflow management, time entry/payroll support, significant event reporting, and medical protocol management. In stage 1604, the method includes receiving user input from one or more of the user-selectable input screens. In stage 1606, the method includes generating and dynamically updating a plurality of work schedules for a respective plurality of workers having different skills working on different aspects of a job at different times as the job progresses. Further, at stage 1608, the method includes managing time keeping, payroll, benefits, and medical protocols for workers beginning and ending work at different times as the job progresses.

Disclosed embodiments may be implemented in hardware, firmware, software, or any combination thereof. Embodiments may also be implemented as instructions stored on a non-transitory machine-readable medium, which may be read and executed by one or more processor circuits (i.e., “processors”). A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical optical, acoustical or other forms of propagated signals (e.g., carrier waves, infrared signals, digital signals, etc.), and others. Firmware, software routines, and computer program instructions may be described herein as performing certain actions or operations. However, such descriptions are merely for convenience of description. Such actions or operations, in fact, result from computing devices, processors, controllers, or other devices executing the firmware, software, routines, instructions, etc.

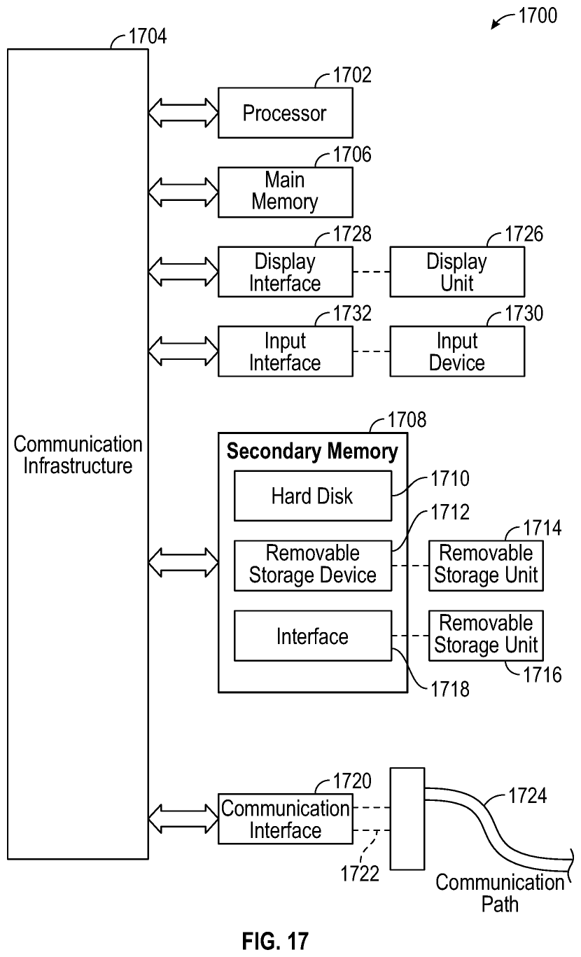

FIG. 17 is a block diagram of an example computer system 1700 in which disclosed embodiments of, or portions thereof, may be implemented as computer-readable code (i.e., machine-readable computer program instructions), which is executed by one or more processors causing the one or more processors to perform operations of the disclosed embodiments.

Disclosed systems may include components implemented on computer system 1700 using hardware, software, firmware, tangible computer-readable (i.e., machine-readable) media having computer program instructions stored thereon, or a combination thereof, and may be implemented in one or more computer systems or other processing system.

If programmable logic is used, such logic may be executed on a commercially available processing platform or a on a special purpose device. One of ordinary skill in the art may appreciate that embodiments of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device.

Various disclosed embodiments are described in terms of this example computer system 1700. After reading this description, persons of ordinary skill in the relevant art will know how to implement disclosed embodiments using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As persons of ordinary skill in the relevant art will understand, a computing device for implementing disclosed embodiments has at least one processor, such as processor 1702, wherein the processor may be a single processor, a plurality of processors, a processor in a multi-core/multiprocessor system, such system operating alone, or in a cluster of computing devices operating in a cluster or server farm. Processor 1702 may be connected to a communication infrastructure 1704, for example, a bus, message queue, network, or multi-core message-passing scheme.

Computer system 1700 may also include a main memory 1706, for example, random access memory (RAM), and may also include a secondary memory 1708. Secondary memory 1708 may include, for example, a hard disk drive 1710, removable storage drive 1712. Removable storage drive 1712 may include a floppy disk drive, a magnetic tape drive, an optical disk drive, a flash memory, or the like. The removable storage drive 1712 may be configured to read and/or write data to a removable storage unit 1714 in a well-known manner. Removable storage unit 1714 may include a floppy disk, magnetic tape, optical disk, etc., which is read by and written to, a removable storage drive 1712. As will be appreciated by persons of ordinary skill in the relevant art, removable storage unit 1714 may include a computer readable storage medium having computer software (i.e., computer program instructions) and/or data stored thereon.

In alternative implementations, secondary memory 1708 may include other similar devices configured to allow computer programs or other instructions to be loaded into computer system 1700. Such devices may include, for example, a removable storage unit 1716 and an interface 1718. Examples of such devices may include a program cartridge and cartridge interface (such as that found in video game devices), a removable memory chip (such as EPROM or PROM) and associated socket, and other removable storage units 1716 and interfaces 1718 which allow software and data to be transferred from the removable storage unit 1716 to computer system 1700.

Computer system 1700 may also include a communications interface 1720. Communications interface 1720 allows software and data to be transferred between computer system 1700 and external devices. Communications interfaces 1720 may include a modem, a network interface (such as an Ethernet card), a communications port, a PCMCIA slot and card, or the like. Software and data transferred via communications interface 1720 may be in the form of signals 1722, which may be electronic, electromagnetic, optical, or other signals capable of being received by communications interface 1720. These signals may be provided to communications interface 1720 via a communications path 1724.

In this document, the terms “computer program storage medium” and “computer usable storage medium” are used to generally refer to storage media such as removable storage unit 1714, removable storage unit 1716, and a hard disk installed in hard disk drive 1710. Computer program storage medium and computer usable storage medium may also refer to memories, such as main memory 1706 and secondary memory 1708, which may be semiconductor memories (e.g., DRAMS, etc.). Computer system 1700 may further include a display unit 1726 that interacts with communication infrastructure 1704 via a display interface 1728. Computer system 1700 may further include a user input device 1730 that interacts with communication infrastructure 1704 via an input interface 1732. A user input device 1730 may include a mouse, trackball, touch screen, or the like.

Computer programs (also called computer control logic or computer program instructions) are stored in main memory 1706 and/or secondary memory 1708. Computer programs may also be received via communications interface 1720. Such computer programs, when executed, enable computer system 1700 to implement embodiments as disclosed herein. In particular, the computer programs, when executed, enable processor 1702 to implement the processes of disclosed embodiments, such as various stages in disclosed methods, as described in greater detail above. Accordingly, such computer programs represent controllers of the computer system 1700. When an embodiment is implemented using software, the software may be stored in a computer program product and loaded into computer system 1700 using removable storage drive 1712, interface 1718, and hard disk drive 1710, or communications interface 1720. A computer program product may include any suitable non-transitory machine-readable (i.e., computer-readable) storage device having computer program instructions stored thereon.

Embodiments may be implemented using software, hardware, and/or operating system implementations other than those described herein. Any software, hardware, and operating system implementations suitable for performing the functions described herein may be utilized. Embodiments are applicable to both a client and to a server or a combination of both.

The disclosure sets forth example embodiments and, as such, is not intended to limit the scope of embodiments of the disclosure and the appended claims in any way. Embodiments have been described above with the aid of functional building blocks illustrating the implementation of specified functions and relationships thereof. The boundaries of these functional building blocks have been arbitrarily defined herein for the convenience of the description. Alternate boundaries can be defined to the extent that the specified functions and relationships thereof are appropriately performed.

The foregoing description of specific embodiments will so fully reveal the general nature of embodiments of the disclosure that others can, by applying knowledge of those of ordinary skill in the art, readily modify and/or adapt for various applications such specific embodiments, without undue experimentation, without departing from the general concept of embodiments of the disclosure. Therefore, such adaptation and modifications are intended to be within the meaning and range of equivalents of the disclosed embodiments, based on the teaching and guidance presented herein. The phraseology or terminology herein is for the purpose of description and not of limitation, such that the terminology or phraseology of the specification is to be interpreted by persons of ordinary skill in the relevant art in light of the teachings and guidance presented herein.

The breadth and scope of embodiments of the disclosure should not be limited by any of the above-described example embodiments, but should be defined only in accordance with the following claims and their equivalents.

What is claimed is:

1. A system for labor scheduling and jobsite management for a dynamically changing workforce, the system comprising:
a graphical user interface (GUI); and
a processor circuit that is configured to perform operations comprising:
controlling the GUI to present a user interface that includes a plurality of user-selectable input screens that allow input of information regarding employee onboarding, flexible staffing and workflow management, time entry/payroll support, significant event reporting, and medical protocol management;
receiving user input from one or more of the user-selectable input screens;
generating and dynamically updating a plurality of work schedules for a respective plurality of workers having different skills working on different aspects of a job at different times as the job progresses; and
managing time keeping, payroll, benefits, and medical protocols for workers beginning and ending work at different times as the job progresses.

2. The system of claim 1, wherein the operation comprising managing time keeping, payroll, benefits, and medical protocols further comprises:
receiving time records for a worker performing work for a temporary assignment; and
processing payroll actions to pay the worker at the completion of the temporary assignment,
wherein the worker begins and ends the temporary assignment at different times from other workers working on the same job.

3. The system of claim 1, wherein the processor is further configured to provide functionality to control various aspects of labor scheduling and jobsite management through a plurality of components that are presented via the GUI, the components comprising:
an operations management platform;
a time tracking platform;
a self-service portal;
an integrated learning management system; and
a third-party billing platform.

4. The system of claim 1, wherein the processor is further configured to communicate with and to exchange data with a single Enterprise Resource Planning (ERP) system or with multiple ERPs.

5. The system of claim 1, wherein the processor is further configured to perform operations comprising:
controlling the GUI to present a dashboard screen providing user-selectable menus providing one or more of:
a targeted task list that is customized for each supervisor or superintendent;
a summary of a selected job;
a summary of a jobsite associated with the selected job;
a work performance summary of an assigned crew;
a list of due and overdue tasks;
a list of significant event reports;
a job queue that provides functionality that allows superintendents to manage a current job and to forecast upcoming jobs;
a time tracking utility; and
information pertaining to a specific user interacting with the GUI.

6. The system of claim 1, wherein the processor is further configured to perform operations comprising:
controlling the GUI to present an operations management screen providing user-selectable menus that provide functionality comprising:
management of job roster creation;
management of job shifts;
management of site requirements, worker training requirements, and worker skills requirements;
management of daily logs;
management of safety reports;
management and scheduling of drug tests;
management of weld reviews, compliance reporting, and audits;
management of customer surveys with targeted reporting; and
management of third-party billing and payroll correction.

7. A processor-implemented method of labor scheduling and jobsite management for a dynamically changing workforce, the method comprising:
controlling, by a processor-circuit, a GUI to present a user interface that includes a plurality of user-selectable input screens that allow input of information regarding employee onboarding, flexible staffing and workflow management, time entry/payroll support, significant event reporting, and medical protocol management;
receiving user input from one or more of the user-selectable input screens;
generating and dynamically updating a plurality of work schedules for a respective plurality of workers having different skills working on different aspects of a job at different times as the job progresses; and
managing time keeping, payroll, benefits, and medical protocols for workers beginning and ending work at different times as the job progresses.

8. The processor-implemented method of claim 7, further comprising:
receiving time records for a worker performing work for a temporary assignment; and
processing payroll actions to pay the worker at the completion of the temporary assignment,
wherein the worker begins and ends the temporary assignment at different times from other workers working on the same job.

9. The processor-implemented method of claim 7, further comprising:
controlling the GUI to present a plurality of components that provide functionality to control various aspects of labor scheduling and jobsite management, the components comprising:
an operations management platform;
a time tracking platform;
a self-service portal;
an integrated learning management system; and
a third-party billing platform.

10. The processor-implemented method of claim 7, further comprising:
communicating with and exchanging data with a single ERP system or with multiple ERPs.

11. The processor-implemented method of claim 7, further comprising:
controlling the GUI to present a dashboard screen providing user-selectable menus providing one or more of:
a targeted task list that is customized for each supervisor or superintendent;
a summary of a selected job;
a summary of a jobsite associated with the selected job;
a work performance summary of an assigned crew;
a list of due and overdue tasks;
a list of significant event reports;
a job queue that provides functionality that allows superintendents to manage a current job and to forecast upcoming jobs;
a time tracking utility; and
information pertaining to a specific user interacting with the GUI.

12. The processor-implemented method of claim 7, further comprising:
controlling the GUI to present an operations management screen providing user-selectable menus that provide functionality comprising:
management of job roster creation;
management of job shifts;
management of site requirements, worker training requirements, and worker skills requirements;
management of daily logs;
management of safety reports;
management and scheduling of drug tests;
management of weld reviews, compliance reporting, and audits;
management of customer surveys with targeted reporting; and
management of third-party billing and payroll correction.

13. A non-transitory computer readable storage device having computer program instructions stored thereon that, when executed by a processor circuit, cause the processor circuit to perform operations that implement a method of labor scheduling and jobsite management for a dynamically changing workforce, the operations comprising:
controlling a GUI to present a user interface that includes a plurality of user-selectable input screens that allow input of information regarding employee onboarding, flexible staffing and workflow management, time entry/payroll support, significant event reporting, and medical protocol management;
receiving user input from one or more of the user-selectable input screens;
generating and dynamically updating a plurality of work schedules for a respective plurality of workers having different skills working on different aspects of a job at different times as the job progresses; and
managing time keeping, payroll, benefits, and medical protocols for workers beginning and ending work at different times as the job progresses.

14. The non-transitory computer readable storage device of claim 13, further comprising computer readable instructions that, when executed by the processor, cause the processor to perform operations comprising:
receiving time records for a worker performing work for a temporary assignment; and
processing payroll actions to pay the worker at the completion of the temporary assignment,
wherein the worker begins and ends the temporary assignment at different times from other workers working on the same job.

15. The non-transitory computer readable storage device of claim 13, further comprising computer readable instructions that, when executed by the processor, cause the processor to perform operations comprising:
controlling the GUI to present a plurality of components that provide functionality to control various aspects of labor scheduling and jobsite management, the components comprising:
an operations management platform;
a time tracking platform;
a self-service portal;
an integrated learning management system; and
a third-party billing platform.

16. The non-transitory computer readable storage device of claim 13, further comprising computer readable instructions that, when executed by the processor, cause the processor to perform operations comprising:
communicating with and exchanging data with a single ERP system or with multiple ERPs.

17. The non-transitory computer readable storage device of claim 13, further comprising computer readable instructions that, when executed by the processor, cause the processor to perform operations comprising:
controlling the GUI to present a dashboard screen providing user-selectable menus providing one or more of:
a targeted task list that is customized for each supervisor or superintendent;
a summary of a selected job;
a summary of a jobsite associated with the selected job;
a work performance summary of an assigned crew;
a list of due and overdue tasks;
a list of significant event reports;
a job queue that provides functionality that allows superintendents to manage a current job and to forecast upcoming jobs;
a time tracking utility; and
information pertaining to a specific user interacting with the GUI.

18. The non-transitory computer readable storage device of claim 13, further comprising computer readable instructions that, when executed by the processor, cause the processor to perform operations comprising:
controlling the GUI to present an operations management screen providing user-selectable menus that provide functionality comprising:
management of job roster creation;
management of job shifts;
management of site requirements, worker training requirements, and worker skills requirements;
management of daily logs;
management of safety reports;
management and scheduling of drug tests;
management of weld reviews, compliance reporting, and audits;
management of customer surveys with targeted reporting; and
management of third-party billing and payroll correction.

19. A non-transitory computer readable storage device having computer program instructions stored thereon that, when executed by a processor circuit, cause the processor circuit to perform operations that implement functionality that includes third-party time tracking, the operations comprising:
generating a web-based GUI on a user device that is configured to perform operations including:
receiving time entries from third-party contractors;
tracking and managing costs for a given jobsite including tracking sub-contracted personnel, third-party equipment, site material costs, and labor costs based on third-party time entries;
tracking separate costs incurred by a primary user versus costs incurred by third-party contractors; and
generating and maintaining a single repository of information regarding all jobsite costs.

20. The non-transitory computer readable storage device of claim 19, further comprising computer readable instructions that, when executed by the processor, cause the processor to perform one or more operations comprising:
processing third-party timecards to generate payroll actions;
reporting third-party timecards to a third-party contractor for payroll processing;
generating and submitting bills to an end customer on behalf of the third-party contractor;
tracking and supplying all aspects of customer financial reporting; and
providing a full centralized billing functionality for an entire job that includes generating activity and progress reporting as well as generating direct invoicing for end customers.
